(19) United States
(12) Patent Application Publication
(10) Pub. No.: US 2007/0265077 A1
(43) Pub. Date: Nov. 15, 2007

(54) Haptic feedback for peripheral devices

(75) Inventors: Dennis W. Tom, Redmond, WA (US); Glenn Steven Arche, Bothell, WA (US); John K. Ikeda, Seattle, WA (US)

Correspondence Address: WOODCOCK WASHBURN LLP (MICROSOFT CORPORATION), CIRA CENTRE, 12TH FLOOR, 2929 ARCH STREET, PHILADELPHIA, PA, 19104-2891, US

(73) Assignee: Microsoft Corporation, Redmond, WA (US)

(21) Appl. No.: 11/413,660

(22) Filed: Apr. 27, 2006

(51) Int. Cl. A63F 13/00

(52) U.S. Cl. 463/37

(57) ABSTRACT

A tactile feedback system including multiple motors is provided for a peripheral device. A steering wheel assembly is provided including a high torque motor in the steering column of the steering wheel assembly and at least one vibratory rumble motor in the steering wheel of the steering wheel of the steering wheel assembly. In one embodiment, the peripheral device includes three motors: a high torque motor, a low frequency rumble motor and a high frequency rumble motor. The entire haptic dynamic range is thus addressed with greater fidelity whereby complex haptic effects can be delivered through independent motors.

### FIELD OF THE INVENTION

The present invention relates to improved haptic feedback apparatus and methods for peripheral device(s), such as steering wheel assemblies.

### BACKGROUND OF THE INVENTION

Traditional force feedback driving gaming controllers currently utilize a single motor to address the whole range of haptic user experiences intended to represent real world tactile experiences. For instance, the dynamic range of desired haptic user experience for a car driving peripheral device intended to simulate various aspects of driving a car include such events as experiencing road noise, experiencing bumps in the road, skidding, feeling engine vibrations, feeling physical forces due to collisions/steering, and so on.

However, the inclusion of only a single motor limits the fidelity of the tactile effects a game can deliver to a user of such existing peripheral devices. This inadequacy can be analogized to trying to deliver the entire human audio range with a single speaker. Just as providing only a subwoofer cannot deliver suitable high frequency sounds and a tweeter generally cannot deliver rich, low frequency sounds with sufficient amplitude, the provision of a single tactile effect from a single motor for a peripheral device cannot achieve the desired range of tactile user experiences for a peripheral device attempting to simulate real world conditions.

In this regard, peripheral devices, such as steering wheel assemblies have thus far provided either only a single high torque motor for providing force feedback to a user, or have provided only a vibratory rumble motor for providing vibratory feedback to a user; however, as one can appreciate, neither tactile effect, by itself, provides a full range of tactile experiences to simulate real world events with sufficient realism. Accordingly, solutions to these and other deficiencies of the state of the art of tactile feedback for peripheral devices are thus desirable.

### SUMMARY OF THE INVENTION

In view of the foregoing, the present invention provides a multi motor tactile feedback system for a peripheral device. In one non-limiting embodiment, the peripheral device is a steering wheel assembly including a high torque motor in the steering column of the steering wheel assembly and at least one vibratory rumble motor in the steering wheel of the steering wheel of the steering wheel assembly. The entire haptic dynamic range is thus addressed with greater fidelity whereby complex haptic effects can be delivered through independent motors. In one embodiment, the peripheral device includes three motors: a high torque motor, a low frequency rumble motor and a high frequency rumble motor.

Other features of the present invention are described below.

### BRIEF DESCRIPTION OF THE DRAWINGS

The haptic feedback apparatus including multiple motors for a peripheral device in accordance with the invention is further described with reference to the accompanying drawings in which:

FIG. 1 illustrates a peripheral device including at least two haptic feedback systems including a force feedback system in accordance with the invention;

FIGS. 2A, 2B, 2C and 2D illustrate various non-limiting embodiments. of a peripheral device including at least two haptic feedback systems including a force feedback system in accordance with the invention;

FIGS. 3A, 3B and 3C illustrate an exemplary, non-limiting implementation of a steering wheel peripheral device including at least two haptic feedback systems including a force feedback system in the steering column in accordance with the invention;

FIGS. 4A and 4B illustrate an exemplary, non-limiting expanded design diagrams of an implementation of a steering wheel peripheral device in accordance with the invention including a high torque motor in the steering column and at least one vibratory motor incorporated in the steering wheel;

FIG. 5 shows an exemplary non-limiting flow diagram for a process for providing tactile feedback to a user of a peripheral device in accordance with the invention;

FIG. 6A is a block diagram representing an exemplary non-limiting computing system environment to which a peripheral device in accordance with the invention may be connected; and

FIG. 6B is a block diagram showing an exemplary non-limiting multimedia console to which a peripheral device in accordance with the invention may be connected.

### DETAILED DESCRIPTION OF ILLUSTRATIVE EMBODIMENTS

### Overview of Terminology

Herein, the following terms should be considered in light of the following terminology overviews provided for the terms. For the avoidance of doubt, where the following terms are used elsewhere herein, the terms should also be considered in the context of use.

Haptic: Of or relating to the sense of touch; tactile

Tactile: Perceptible to the sense of touch; tangible, or of, relating to, or proceeding from the sense of touch.

Force Feedback: Feedback producing a controllable torque on at least one mechanical component of a peripheral device, tending to inhibit or aid the user's ability to impart a force on the at least one mechanical component.

Torque: The moment of a force; the measure of a force's tendency to produce torsion and rotation about an axis, equal to the vector product of the radius vector from the axis of rotation to the point of application of the force and the force vector. A turning or twisting force.

Vibratory Feedback: Feedback causing vibration or oscillation to one or more parts of a user in contact with a peripheral device.

### Improved Haptic Feedback System for Peripheral Devices

As mentioned in the background, current haptic feedback apparatus for peripheral devices provide either force feedback via a high torque motor, or rumble feedback via a vibratory motor, but either provided by itself limits the overall fidelity of a tactile user experience that may be experienced by a user.

Accordingly, the invention provides peripheral device(s) for providing input to a computing device, including a first haptic feedback mechanism for providing first tactile feedback to a user when in contact with the first haptic feedback mechanism and a second haptic feedback mechanism, operating independently of the first haptic feedback mechanism, for providing second tactile feedback to a user when in contact with the second haptic feedback mechanism, wherein one of the haptic feedback mechanisms is a force feedback system having a high torque motor and one of the haptic feedback mechanisms is a vibratory or rumble feedback system having vibratory motors. In one embodiment, the vibratory motors include high frequency and low frequency rumble motors.

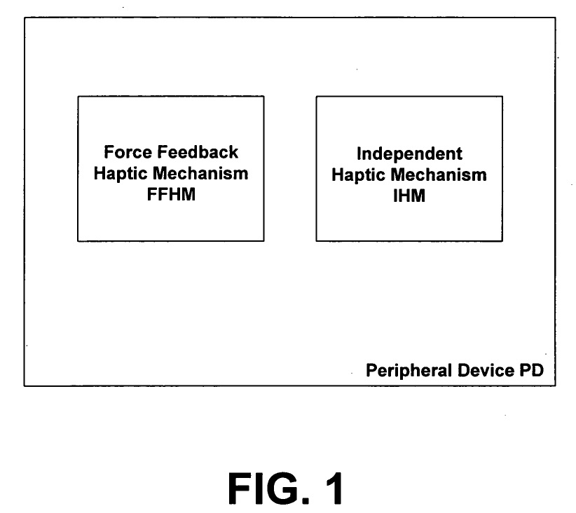

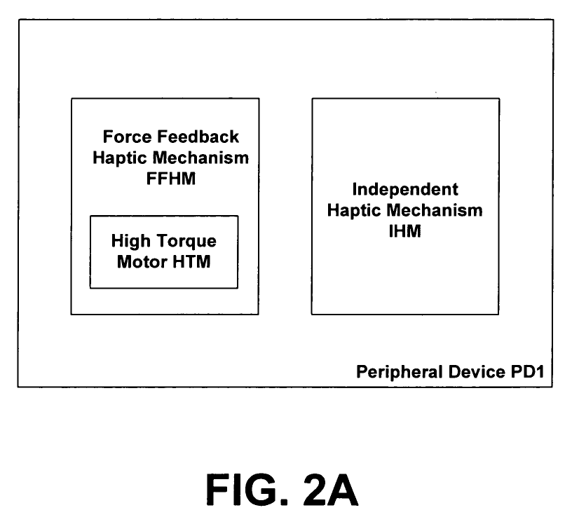

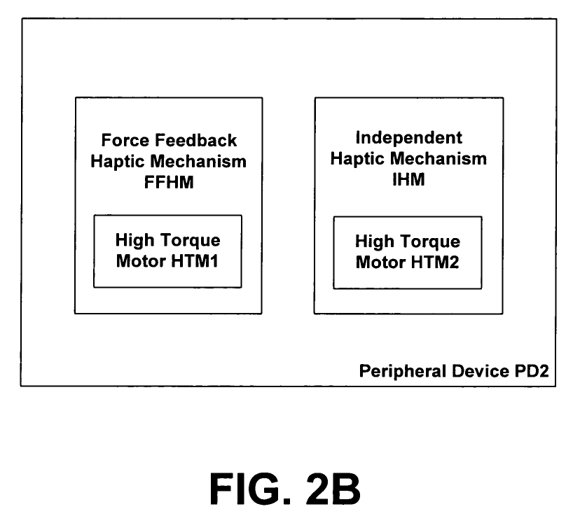

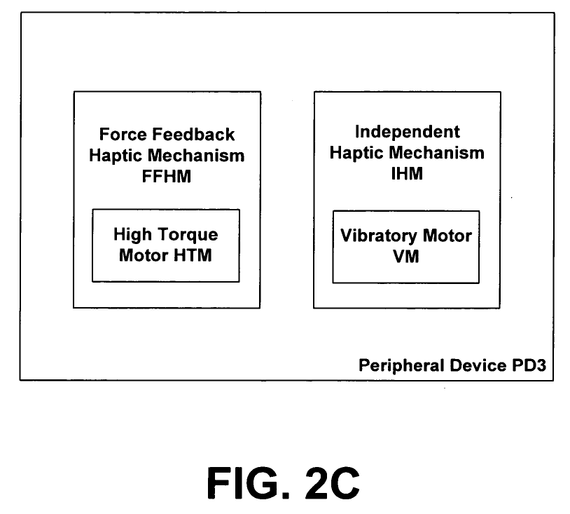

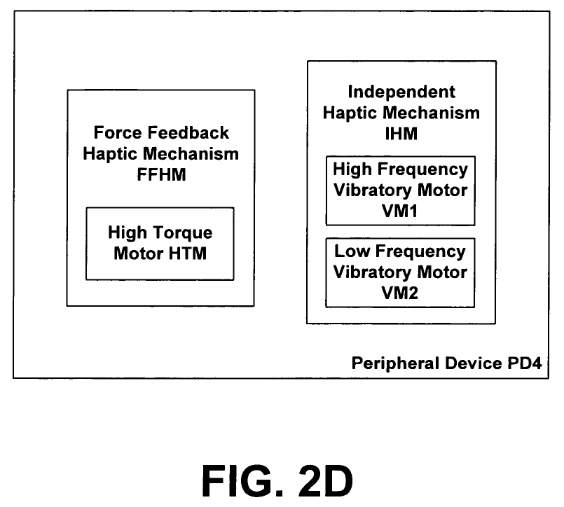

As illustrated in FIG. 1, the invention provides a peripheral device PD including a force feedback haptic mechanism FFHM and another, independent haptic mechanism IHM. As shown in FIG. 2A, in a peripheral device PD1, the force feedback haptic mechanism FFHM includes a high torque motor HTM. As shown in FIG. 2B, in a peripheral device PD2, the force feedback haptic mechanism FFHM includes a high torque motor HTM1 and the independent haptic mechanism IHM includes a high torque motor HTM2. As shown in FIG. 2C, in a peripheral device PD3, the independent haptic mechanism IHM includes a vibratory or oscillatory motor VM. Furthermore, as shown in FIG. 2D, in a peripheral device PD4, the independent haptic mechanism IHM includes a high frequency vibratory motor VM1 and a low frequency vibratory motor VM2.

The terms “high frequency” motor and “low frequency” motor used in connection with providing a vibration effect for peripheral devices are generally understood by those of ordinary skill in the art, but to provide some exemplary non-limiting ranges for such terms, high frequency motor VM1 may vibrate generally in the range of 50-100 Hz (but generally vibrates at a lower amplitude of vibration) whereas low frequency motor VM2 may generally vibrate at a lower frequency range of 10-70 Hz (but generally vibrates at a higher amplitude of vibration). Thus, the ranges contemplated herein for high and low frequency motors may overlap, and amplitudes may be disparate between the two motors. As mentioned, the invention may include two or more such motors as well, and thus the invention contemplates a full swath of ranges that may be permuted or combined per the set of motors provided for the peripheral device.

In an exemplary non-limiting embodiment of the invention, the peripheral device is a steering wheel assembly including a steering wheel mechanically coupled to a steering column including a high torque motor within the steering column that operates to impart a torque on the steering column which tends to make turning the steering wheel more or less difficult depending on the control signals delivered to the high torque motor.

In another non-limiting embodiment of the invention, the peripheral device is a steering wheel assembly including a steering wheel mechanically coupled to a steering column, and the vibratory motor(s) are included in the steering wheel. The vibratory motor(s) may be positioned generally about where the user grips the steering wheel, however, the vibratory motor(s) can be positioned anywhere in the steering wheel in accordance with the invention without significantly impacting the tactile feedback experienced by the user since vibratory feedback from a rumble motor tends to propagate throughout the steering wheel in such an integrated design.

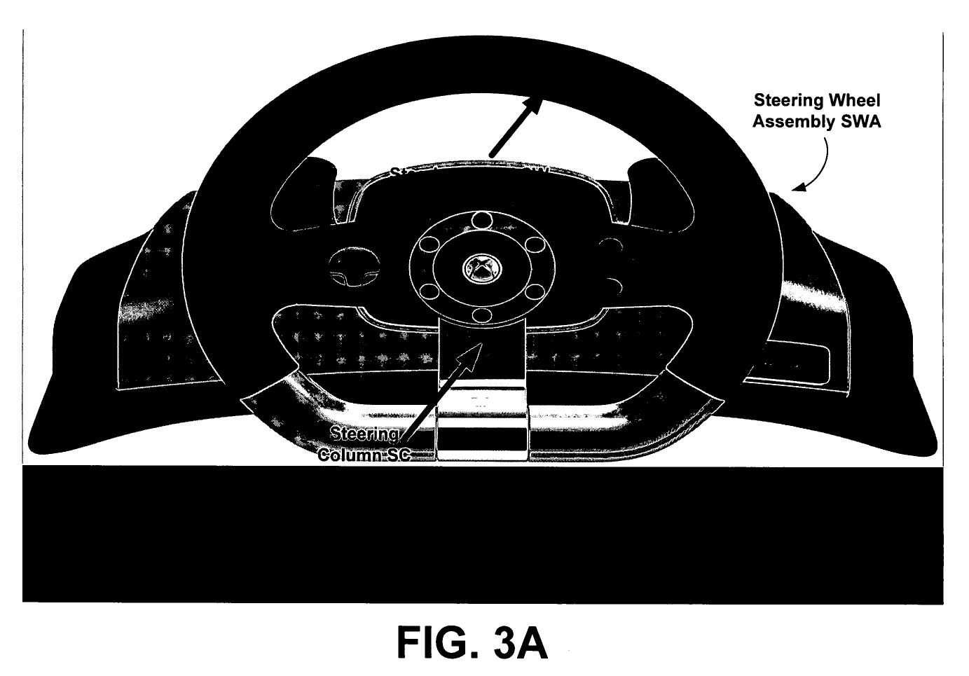

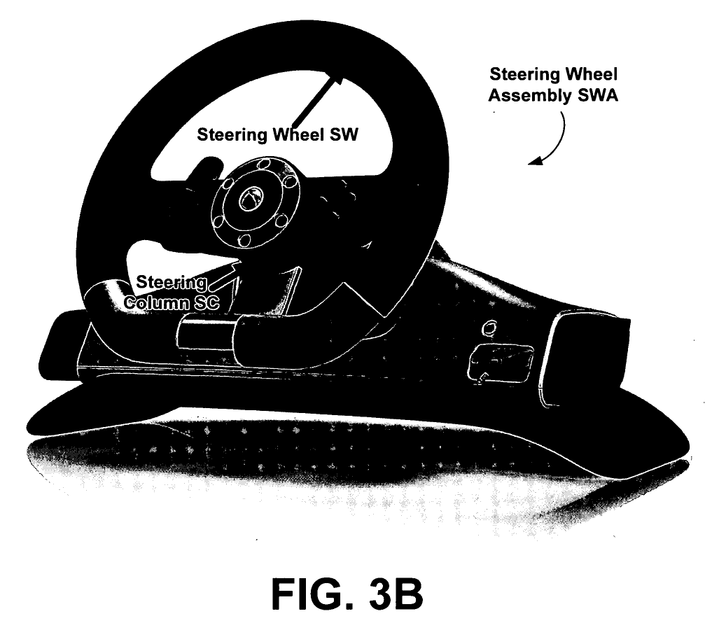

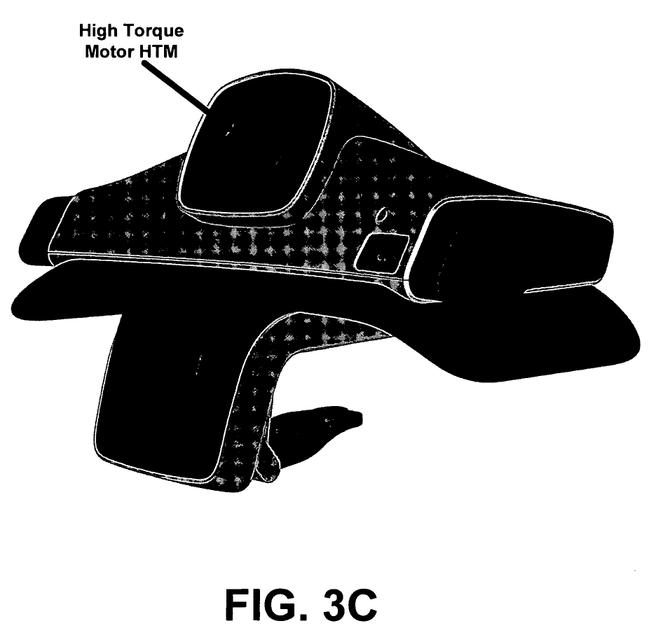

FIGS. 3A, 3B and 3C show a design diagram of an implementation of the invention as a steering wheel assembly SWA. In this regard, the steering column SC includes a high torque motor for delivering torque to the steering column, and the steering wheel SW includes vibratory motors (e.g., high and low frequency motors) for delivering vibrations to a user's hands gripping the steering wheel SW. FIG. 3C illustrates that a high torque motor HTM can be implemented as a force feedback mechanism and mechanically coupled to, or integrated with, the steering column mechanism in order to deliver a torque to the steering column.

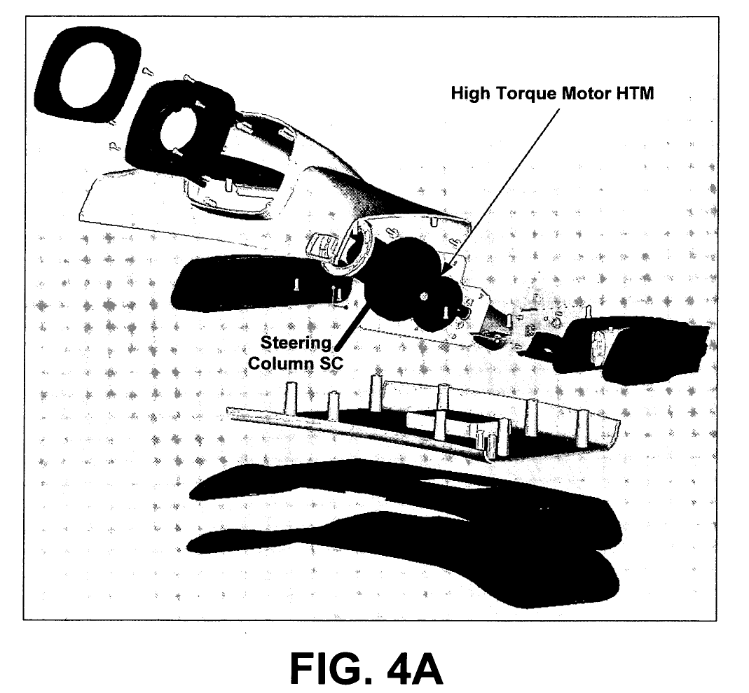

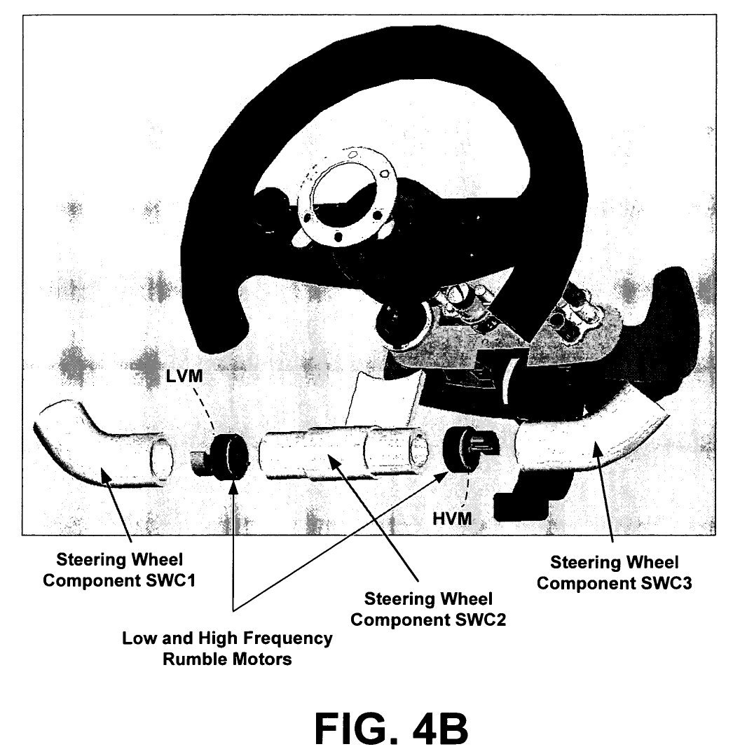

FIG. 4A shows an expanded component diagram of a steering wheel assembly implementation of the invention showing a high torque motor HTM integrated with and mechanically coupled to a steering column SC of the steering wheel assembly. FIG. 4B shows an expanded component diagram of a steering wheel assembly implementation of the invention including a steering wheel that includes at least components SWC1, SWC2 and SWC3, one or more of which house low and high frequency motors LVM and HVM in accordance with the invention.

A peripheral device in accordance with the invention also includes control mechanisms and associated APIs that control the force feedback mechanism and the vibratory mechanisms independently.

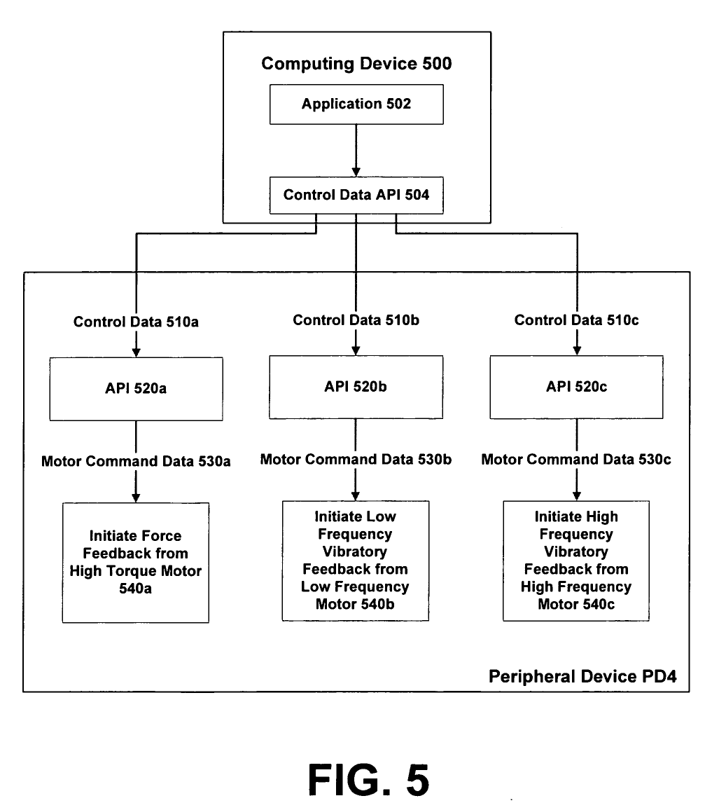

FIG. 5 shows an exemplary non-limiting flow diagram for a process for providing tactile feedback to a user of a peripheral device in accordance with the invention. first motor is a high frequency rumble motor and the second motor is a low frequency rumble motor, and wherein both the high frequency rumble motor and the low frequency rumble motor are integrated into a steering wheel of a steering wheel assembly.

The process of FIG. 5 includes receiving a request from computing device 500, or an application 502 executing thereon, for a pre-defined haptic effect to occur via one or more of the multiple motors of the peripheral device, such as peripheral device PD4. The request is received by a control data API 504, which optionally handles all such requests, or may be divided into independent API sets, as one can appreciate, for each motor subsystem. An advantage of providing an integrated API 504 is the high level exposure of haptic effects to application and game developers. For instance, rather than making calls to the high torque motor, the low frequency rumble motor and the high frequency rumble motor individually from the standpoint of application 502, the software developer can make calls that achieve certain effects, such as “request ‘road noise’ haptic feedback,” “request ‘sliding on road’ haptic feedback,” and the like, and then API 504 can automatically handle the appropriate control data for controlling the various motors individually based on pre-determined control data defined for such effects.

Thus, after an application 502 or computing device 500 makes a request for an effect, and after control data API 504 computes the associated control data 510a, 510b and 510c for handling by the different motor subsystems of the peripheral device PD4, the control data 510a, 510b and 510c is transmitted to API 520a, API 520b and API 520c, respectively, each for independently interfacing with a separate motor subsystem. For instance, API 520a receives control data 510a and translates the control data 510a to motor command data or signals 530a for controlling force feedback of a high torque motor. As shown at 540a, motor command data 530a can, for example, initiate a force feedback haptic response by high torque motor.

API 520b independently receives control data 510b and translates the control data 510b to motor command data or signals 530b for controlling vibratory feedback of a low frequency rumble motor. As shown at 540b, motor command data 530b can, for example, initiate a vibratory haptic response by a low frequency rumble motor. Similarly, API 520c independently receives control data 510c and translates the control data 510c to motor command data or signals 530c for controlling vibratory feedback of a high frequency rumble motor. As shown at 540c, motor command data 530c can, for example, initiate a vibratory haptic response by a high frequency rumble motor. The motor subsystems can also be combined in subsets from a control standpoint. For instance, a first set of control data could apply to the force feedback motor subsystem, and a second set of control data could apply to the vibratory feedback motor subsystem, including both low and high frequency motors.

In another exemplary non-limiting implementation of the invention, a peripheral device is provided including a steering wheel assembly comprising a steering column including a high torque motor for applying a torque to the steering column and a steering wheel mechanically coupled to the steering column, wherein the steering wheel includes vibratory motor(s) integrated with the steering wheel for oscillating the steering wheel. The two rumble motors are place within the steering wheel for maximum transference of effects to the user's hands and the high torque motor drives a gear train for torque generation. By having three separate independently operating motors, one can deliver a range of haptic effects above and beyond one or even two motors can deliver. More than three motors would provide the opportunity to provide an even greater dynamic range of haptic feedback to a user, and thus, the invention is not limited to any particular number of motors included in a peripheral device, but contemplates all such combinations and permutations of force feedback and vibratory motor systems for a peripheral device.

Accordingly, in various non-limiting embodiments, the present invention provides a peripheral device, such as but not limited to a steering wheel assembly, wherein the peripheral device includes at least two motors, one of which is a force feedback mechanism, to provide a greater dynamic range of tactile user experiences.

With the ever expanding universe of devices, any of the above-described peripheral devices can be utilized in connection with applications, such as gaming applications, of a variety of computing devices. Such computing devices in accordance with the invention include (a) portable media players, such as MP3 players, walkmans, etc., (b) portable computing devices, such as laptops, personal digital assistants (“PDAs”), cell phones, portable email devices, thin clients, portable gaming devices (e.g., portable Playstation, Gameboy), etc., (c) standalone computing devices, such as personal computers (“PCs”), server computers, gaming platforms (e.g., Xbox) mainframes, etc., (d) consumer electronic devices, such as TVs, DVD players, set top boxes, monitors, displays, etc., (e) public computing devices, such as kiosks, in-store music sampling devices, automated teller machines (ATMs), arcade machines, cash registers, etc. and (f) non-conventional computing devices, such as kitchen appliances, motor vehicle controls (e.g., steering wheels), etc.

In this regard, a peripheral device of the invention may provide input and/or receive output from any of such computing devices where the peripheral device can generally be attached to augment input and/or output characteristics of the computing device. Two exemplary, non-limiting computing devices to which a peripheral device having pedal(s) of the invention may be communicatively coupled are described in exemplary fashion as follows.

### Exemplary Computing Device

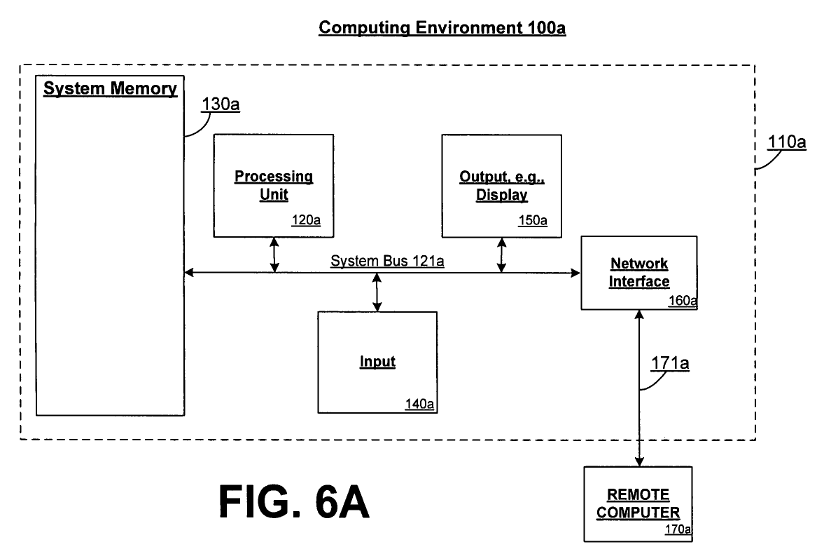

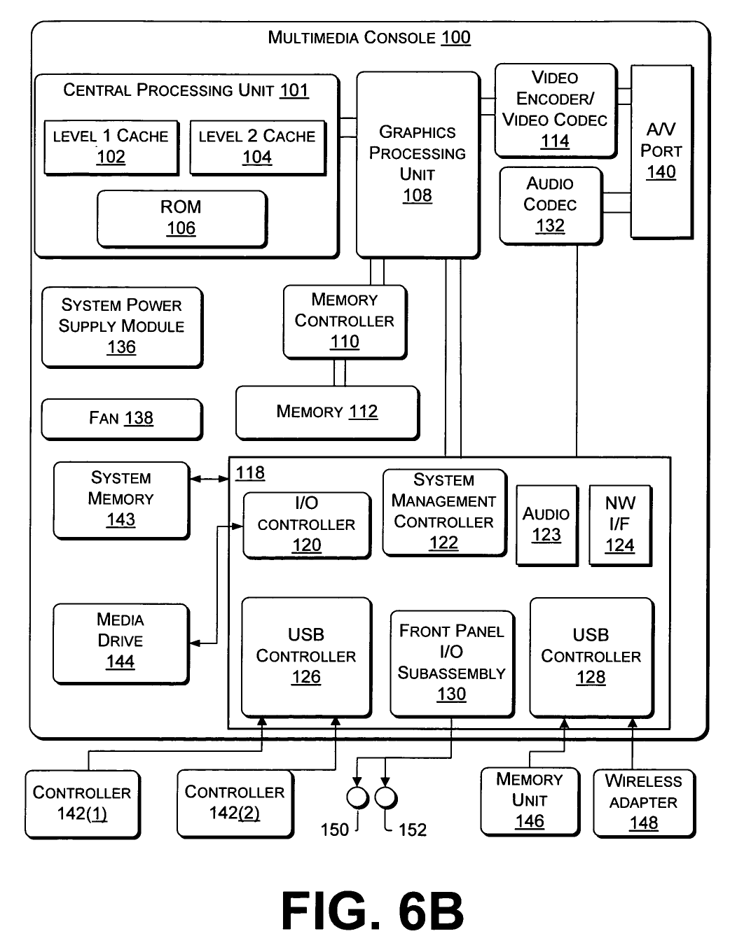

As mentioned, the invention applies to any device wherein it may be desirable to include an input device for receiving input from a human being and to provide a tactile user experience via multiple motors of the peripheral device. It should be understood, however, as indicated above, that handheld, portable and other computing devices and computing objects of all kinds are contemplated for use in connection with an input device of the present invention. Accordingly, the below general purpose remote computer described below in FIG. 6A is but one example, and the present invention may be implemented with any client or portable device, whether standalone or having network/bus interoperability and interaction. Thus, the present invention may be implemented in an environment of networked hosted services in which very little or minimal client resources are implicated, e.g., a networked environment in which the client device serves merely as an interface to the network/bus, such as an object placed in an appliance.

Although not required, the invention can partly be implemented via an operating system, for use by a developer of services for a device or object, and/or included within application software that operates in connection with the peripheral device(s)of the invention. Software may be described in the general context of computer-executable instructions, such as program modules, being executed by one or more computers, such as client workstations, servers or other devices. Those skilled in the art will appreciate that the invention may be practiced with other computer system configurations and protocols.

FIG. 6A thus illustrates an example of a suitable computing system environment 100a in which the invention may be implemented, although as made clear above, the computing system environment 100a is only one example of a suitable computing environment for an input device and is not intended to suggest any limitation as to the scope of use or functionality of the invention. Neither should the computing environment 100a be interpreted as having any dependency or requirement relating to any one or combination of components illustrated in the exemplary operating environment 100a.

With reference to FIG. 6A, an exemplary remote device for implementing the invention includes a general purpose computing device in the form of a computer 110a. Components of computer 110a may include, but are not limited to, a processing unit 120a, a system memory 130a, and a system bus 121a that couples various system components including the system memory to the processing unit 120a. The system bus 121a may be any of several types of bus structures including a memory bus or memory controller, a peripheral bus, and a local bus using any of a variety of bus architectures.

Computer 110a typically includes a variety of computer readable media. Computer readable media can be any available media that can be accessed by computer 110a. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 110a. Communication media typically embodies computer readable instructions, data structures, program modules or other data in a modulated data signal such as a carrier wave or other transport mechanism and includes any information delivery media.

The system memory 130a may include computer storage media in the form of volatile and/or nonvolatile memory such as read only memory (ROM) and/or random access memory (RAM). A basic input/output system (BIOS), containing the basic routines that help to transfer information between elements within computer 110a, such as during start-up, may be stored in memory 130a. Memory 130a typically also contains data and/or program modules that are immediately accessible to and/or presently being operated on by processing unit 120a. By way of example, and not limitation, memory 130a may also include an operating system, application programs, other program modules, and program data.

The computer 110a may also include other removable/non-removable, volatile/nonvolatile computer storage media. For example, computer 110a could include a hard disk drive that reads from or writes to non-removable, nonvolatile magnetic media, a magnetic disk drive that reads from or writes to a removable, nonvolatile magnetic disk, and/or an optical disk drive that reads from or writes to a removable, nonvolatile optical disk, such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM and the like. A hard disk drive is typically connected to the system bus 121a through a non-removable memory interface such as an interface, and a magnetic disk drive or optical disk drive is typically connected to the system bus 121a by a removable memory interface, such as an interface.

In addition to a peripheral device according to the invention, a user may enter commands and information into the computer 110a through input devices such as a keyboard and pointing device, commonly referred to as a mouse, trackball or touch pad. In addition to a peripheral device in accordance with the invention, other input devices may include a microphone, joystick, game pad, satellite dish, scanner, or the like. These and other input devices are often connected to the processing unit 120a through user input 140a and associated interface(s) that are coupled to the system bus 121a, but may be connected by other interface and bus structures, such as a parallel port, game port or a universal serial bus (USB). A graphics subsystem may also be connected to the system bus 121a. A monitor or other type of display device is also connected to the system bus 121a via an interface, such as output interface 150a, which may in turn communicate with video memory. In addition to a monitor, computers may also include other peripheral output devices such as speakers and a printer, which may be connected through output interface 150a.

The computer 110a may operate in a networked or distributed environment using logical connections to one or more other remote computers, such as remote computer 170a, which may in turn have media capabilities different from device 110a. The remote computer 170a may be a personal computer, a server, a router, a network PC, a peer device or other common network node, or any other remote media consumption or transmission device, and may include any or all of the elements described above relative to the computer 110a. The logical connections depicted in FIG. 6A include a network 171a, such local area network (LAN) or a wide area network (WAN), but may also include other networks/buses. Such networking environments are commonplace in homes, offices, enterprise-wide computer networks, intranets and the Internet.

When used in a LAN networking environment, the computer 110a is connected to the LAN 171 a through a network interface or adapter. When used in a WAN networking environment, the computer 110a typically includes a modem or other means for establishing communications over the WAN, such as the Internet. A modem, which may be internal or external, may be connected to the system bus 121a via the user input interface of input 140a, or other appropriate mechanism. In a networked environment, program modules depicted relative to the computer 110a, or portions thereof, may be stored in a remote memory storage device. It will be appreciated that the network connections shown and described are exemplary and other means of establishing a communications link between the computers may be used.

### Exemplary Multimedia Console Environment

Referring next to FIG. 6B, shown is a block diagram illustrating another exemplary non-limiting computing device, i.e., an exemplary multimedia console, to which a peripheral device having pedal(s) of the invention may be connected via wired or wireless means. FIG. 6B shows the functional components of a multimedia console 100 in which aspects of the invention may be implemented. The multimedia console 100 has a central processing unit (CPU) 101 having a level 1 (LI) cache 102, a level 2 (L2) cache 104, and a flash ROM (Read-only Memory) 106. The level 1 cache 102 and level 2 cache 104 temporarily store data and hence reduce the number of memory access cycles, thereby improving processing speed and throughput. The flash ROM 106 may store executable code that is loaded during an initial phase of a boot process when the multimedia console 100 is powered. Alternatively, the executable code that is loaded during the initial boot phase may be stored in a FLASH memory device (not shown). Further, ROM 106 may be located separate from CPU 101.

A graphics processing unit (GPU) 108 and a video encoder/video codec (coder/decoder) 114 form a video processing pipeline for high speed and high resolution graphics processing. Data is carried from the graphics processing unit 108 to the video encoder/video codec 114 via a bus. The video processing pipeline outputs data to an A/V (audio/video) port 140 for transmission to a television or other display. A memory controller 110 is connected to the GPU 108 and CPU 101 to facilitate processor access to various types of memory 112, such as, but not limited to, a RAM (Random Access Memory).

The multimedia console 100 includes an I/O controller 120, a system management controller 122, an audio processing unit 123, a network interface controller 124, a first USB host controller 126, a second USB controller 128 and a front panel I/O subassembly 130 that are preferably implemented on a module 118. The USB controllers 126 and 128 serve as hosts for peripheral controllers 142(1)-142(2), a wireless adapter 148, and an external memory unit 146 (e.g., flash memory, external CD/DVD ROM drive, removable media, etc.). The network interface 124 and/or wireless adapter 148 provide access to a network (e.g., the Internet, home network, etc.) and may be any of a wide variety of various wired or wireless interface components including an Ethernet card, a modem, a Bluetooth module, a cable modem, and the like.

System memory 143 is provided to store application data that is loaded during the boot process. A media drive 144 is provided and may comprise a DVD/CD drive, hard drive, or other removable media drive, etc. The media drive 144 may be internal or external to the multimedia console 100. Application data may be accessed via the media drive 144 for execution, playback, etc. by the multimedia console 100. The media drive 144 is connected to the I/O controller 120 via a bus, such as a Serial ATA bus or other high speed connection (e.g., IEEE 1394).

The system management controller 122 provides a variety of service functions related to assuring availability of the multimedia console 100. The audio processing unit 123 and an audio codec 132 form a corresponding audio processing pipeline with high fidelity and stereo processing. Audio data is carried between the audio processing unit 123 and the audio codec 126 via a communication link. The audio processing pipeline outputs data to the A/V port 140 for reproduction by an external audio player or device having audio capabilities.

The front panel I/O subassembly 130 supports the functionality of the power button 150 and the eject button 152, as well as any LEDs (light emitting diodes) or other indicators exposed on the outer surface of the multimedia console 100. A system power supply module 136 provides power to the components of the multimedia console 100. A fan 138 cools the circuitry within the multimedia console 100.

The CPU 101, GPU 108, memory controller 110, and various other components within the multimedia console 100 are interconnected via one or more buses, including serial and parallel buses, a memory bus, a peripheral bus, and a processor or local bus using any of a variety of bus architectures.

When the multimedia console 100 is powered on or rebooted, application data may be loaded from the system memory 143 into memory 112 and/or caches 102, 104 and executed on the CPU 101. The application may present a graphical user interface that provides a consistent user experience when navigating to different media types available on the multimedia console 100. In operation, applications and/or other media contained within the media drive 144 may be launched or played from the media drive 144 to provide additional functionalities to the multimedia console 100.

The multimedia console 100 may be operated as a standalone system by simply connecting the system to a television or other display. In this standalone mode, the multimedia console 100 may allow one or more users to interact with the system, watch movies, listen to music, and the like. However, with the integration of broadband connectivity made available through the network interface 124 or the wireless adapter 148, the multimedia console 100 may further be operated as a participant in a larger network community.

The multimedia console depicted in FIG. 6B is a typical multimedia console that may be used to execute a multimedia application; such as, for example, a game. Multimedia applications may be enhanced with system features including for example, system settings, voice chat, networked gaming, the capability of interacting with other users over a network, e-mail, a browser application, etc. Such system features enable improved functionality for multimedia console 100, such as, for example, players in different locations can play a common game via the Internet.

Also, over time, system features may be updated or added to a multimedia application. Rather than requiring the multimedia developer to make significant modifications to the multimedia application to provide these system features, the systems and methods described herein allow a multimedia developer to provide system features through separate system applications that work in conjunction with the multimedia application. For example, a system application may embody functionality related to networked capabilities, thereby enabling a multimedia application to be readily adapted to provide networked capabilities with little work by the multimedia (e.g., game) developer. One such capability is that of system level notifications for multiple and networked users. Making system level notifications part of a system application as opposed to being handled by individual multimedia applications, such as games running on the system, takes handling displaying notifications such as game invitations out of the development process for multimedia application developers and allows them to focus on the multimedia application itself.

For the avoidance of doubt, use of the invention is contemplated from the standpoint of an API (or other software object), either on a host device being controlled by an input device of the invention where the input device operates as a remote control, or on the input device itself. Thus, various implementations of the invention described herein may have aspects that are wholly in hardware, partly in hardware and partly in software, as well as in software.

As mentioned above, while exemplary embodiments of the present invention have been described in connection with various computing devices and network architectures, the underlying concepts may be applied to any computing device or system in which an input device may be utilized to control the device or system. For instance, the algorithm(s) and hardware implementations of the invention may be applied to the operating system of a computing device, provided as a separate object on the device, as part of another object, as a reusable control, as a downloadable object from a server, as a “middle man” between a device or object and the network, as a distributed object, as hardware, in memory, a combination of any of the foregoing, etc. While exemplary programming languages, names and examples are chosen herein as representative of various choices, these languages, names and examples are not intended to be limiting. FIG. 5 illustrates one way of implementing an algorithmic flow for handling non-linear force signals in accordance with the invention; however, one of ordinary skill in the art will appreciate that there are numerous ways of providing object code and nomenclature that achieves the same, similar or equivalent functionality achieved by the various embodiments of the invention.

As mentioned, the various techniques described herein may be implemented in connection with hardware or software or, where appropriate, with a combination of both. Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computing device generally includes a processor, a storage medium readable by the processor (including volatile and non-volatile memory and/or storage elements), at least one input device, and at least one output device. One or more programs that may implement or utilize any software provided in accordance with the invention are preferably implemented in a high level procedural or object oriented programming language to communicate with a computer system. However, the program(s) can be implemented in assembly or machine language, if desired. In any case, the language may be a compiled or interpreted language, and combined with hardware implementations.

The methods and apparatus of the present invention may also be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, etc., the machine becomes an apparatus for practicing the invention. When implemented on a general-purpose processor, the program code combines with the processor to provide a unique apparatus that operates to invoke the functionality of the present invention. Additionally, any storage techniques used in connection with the present invention may invariably be a combination of hardware and software.

While the present invention has been described in connection with the preferred embodiments of the various figures, it is to be understood that other similar embodiments may be used or modifications and additions may be made to the described embodiment for performing the same function of the present invention without deviating therefrom. For example, one skilled in the art will recognize that the methods, as described in the present application may apply to any computing device or environment, such as a gaming console, handheld computer, portable computer, etc., whether wired or wireless, and may be applied to any number of such computing devices connected via a communications network, and interacting across the network.

Furthermore, it should be emphasized that a variety of computer platforms, including handheld device operating systems and other application specific operating systems are contemplated, especially as the number of wireless networked devices continues to proliferate. Still further, functionality of the present invention may be implemented in or across a plurality of processing chips or devices, and storage may similarly be effected across a plurality of devices. Therefore, the present invention should not be limited to any single embodiment, but rather should be construed in breadth and scope in accordance with the appended claims.

What is claimed:

1. A peripheral device for providing input to a computing device, including:
a first haptic feedback mechanism for providing first tactile feedback to a user when in contact with the first haptic feedback mechanism;
a second haptic feedback mechanism for providing, independent of the first haptic feedback mechanism, second tactile feedback to a user when in contact with the second haptic feedback mechanism;
wherein at least one of the first haptic feedback mechanism or the second haptic feedback mechanism is a force feedback system.

2. A peripheral device according to claim 1, wherein the first haptic feedback mechanism is the force feedback system, and wherein the force feedback system includes a high torque motor for providing force feedback to the user.

3. A peripheral device according to claim 2, wherein the second haptic feedback mechanism includes a first motor for providing first vibratory tactile feedback to the user.

4. A peripheral device according to claim 3, wherein the peripheral device is a steering wheel assembly including a steering wheel mechanically coupled to a steering column, and wherein the high torque motor is included with the steering column.

5. A peripheral device according to claim 3, wherein the peripheral device is a steering wheel assembly including a steering wheel mechanically coupled to a steering column, and wherein the first motor is included in the steering wheel.

6. A peripheral device according to claim 3, further comprising:
a third haptic feedback mechanism including a second motor for providing second vibratory tactile feedback to the user independent of first vibratory tactile feedback of the first motor of the second haptic feedback mechanism.

7. A peripheral device according to claim 6, wherein the first motor is a high frequency rumble motor and the second motor is a low frequency rumble motor.

8. A peripheral device according to claim 3, wherein the peripheral device is a steering wheel assembly including a steering wheel mechanically coupled to a steering column, and wherein the first motor is included in the steering wheel.

9. A peripheral device according to claim 1, further including:
a computer readable medium bearing computer executable instructions for receiving first control input for controlling the first haptic feedback mechanism; and
a computer readable medium bearing computer executable instructions for receiving second control input for controlling the second haptic feedback mechanism.

10. A peripheral device according to claim 9, wherein said computer executable instructions for receiving second control input execute independently of said computer executable instructions for receiving first control input.

11. A peripheral device according to claim 1, further comprising:
an application programming interface stored on a computer readable medium for processing signals representative of the first and second tactile feedback and for transmitting the processed signals to a computing device to which the peripheral device is connected.

12. A method for providing tactile feedback to a user of a peripheral device, comprising:
receiving first control data;
initiating the output of first tactile feedback from a first haptic feedback mechanism of the peripheral device in response to the first control data;
receiving second control data; and
initiating the output of second tactile feedback from a second haptic feedback mechanism of the peripheral device in response to the second control data,
wherein said first haptic feedback mechanism is a force feedback system including a high torque motor for outputting force feedback as said first tactile feedback, and wherein said output of the first tactile feedback based on the first control data is initiated independent of the output of the second tactile feedback based on the second control data.

13. A method according to claim 12, wherein said initiating of the output of second tactile feedback from the second haptic feedback mechanism includes initiating the output of a first vibratory motor for outputting first vibratory tactile feedback as said second tactile feedback.

14. A method according to claim 13, wherein said initiating of the output of second tactile feedback from the second haptic feedback mechanism includes initiating the output of the first vibratory motor included in a steering wheel grip of a steering wheel assembly peripheral device.

15. A method according to claim 12, wherein said initiating of the output of first tactile feedback from the first haptic feedback mechanism includes initiating the output of a high torque motor integrated with a steering column of a steering wheel assembly peripheral device.

16. A method according to claim 12, further comprising:
receiving third control data; and
initiating the output of third tactile feedback from a third haptic feedback mechanism of the peripheral device in response to the third control data, and wherein said output of the third tactile feedback based on the third control data is initiated independent of the output of the second tactile feedback based on the second control data and the output of the first tactile feedback based on the first control data.

17. A method according to claim 16, wherein said initiating of the output of the third tactile feedback from the third haptic feedback mechanism includes initiating the output of second vibratory tactile feedback from a second vibratory motor of the third haptic feedback mechanism.

18. A method according to claim 16, wherein the first motor is a high frequency rumble motor and the second motor is a low frequency rumble motor, and wherein both the high frequency rumble motor and the low frequency rumble motor are integrated into a steering wheel of a steering wheel assembly.

19. A peripheral device comprising means for performing the method of claim 11.

20. A peripheral device, including:
a steering wheel assembly comprising:
a steering column including a high torque motor for applying a torque to the steering column; and
a steering wheel mechanically coupled to the steering column, wherein the steering wheel includes at least one vibratory motor integrated with the steering wheel for oscillating the steering wheel.

21. A peripheral device according to claim 20, wherein the at least one vibratory motor includes a high frequency rumble motor and a low frequency rumble motor.
